(19) United States
(12) Patent Application Publication
(10) Pub. No.: US 2012/0232717 A1
(43) Pub. Date: Sep. 13, 2012

(54) REMOTE COORDINATE IDENTIFIER SYSTEM AND METHOD FOR AIRCRAFT

(75) Inventor: Paul Michael Koppie, Palm Harbor, FL (US)

(73) Assignee: HONEYWELL INTERNATIONAL INC., Morristown, NJ (US)

(21) Appl. No.: 12/754,855

(22) Filed: Apr. 6, 2010

(51) Int. Cl. G01C 21/00; B64C 19/00

(52) U.S. Cl. 701/2; 701/445

(57) ABSTRACT

A remote coordinate identifier system for an aircraft comprises a global positioning system (GPS) receiver onboard the aircraft, an inertial navigation system (INS) onboard the aircraft, a laser targeting system (LTS) onboard the aircraft, and a computer onboard the aircraft. The GPS receiver is configured to provide position information of the aircraft during flight. The INS is configured to provide inertial information of the aircraft during flight. The LTS is configured to provide angular information and distance measurements from the aircraft to an identified target during flight. The computer is configured to process the position information, the inertial information, the angular information, and the distance measurements to triangulate a position of the target. The computer determines map coordinates for the target from the triangulated position of the target.

### BACKGROUND

Unmanned aircraft such as Remote Piloted Vehicles (RPVs) are used in both civilian and military operations, such as for surveillance, reconnaissance, target attack missions, and the like. When used in military applications, RPVs are limited in the number of munitions they can carry for target destruction. Thus, additional munitions such as missiles are required to be fired either remotely from afar, or by the use of additional armed aircraft. If missiles are to be fired remotely from afar, the missiles need map coordinates to accurately strike the target. Likewise, if additional aircraft will be launched to attack the target, such aircraft will need the location of the target for the attack.

Currently, aircraft such as RPVs do not have a way to accurately determine the map coordinates of a target that can be used for subsequent armed target strikes.

### SUMMARY

A remote coordinate identifier system for an aircraft comprises a global positioning system (GPS) receiver onboard the aircraft, an inertial navigation system (INS) onboard the aircraft, a laser targeting system (LTS) onboard the aircraft, and a computer onboard the aircraft. The GPS receiver is configured to provide position information of the aircraft during flight. The INS is configured to provide inertial information of the aircraft during flight. The LTS is configured to provide angular information and distance measurements from the aircraft to an identified target during flight. The computer is configured to process the position information, the inertial information, the angular information, and the distance measurements to triangulate a position of the target. The computer determines map coordinates for the target from the triangulated position of the target.

### BRIEF DESCRIPTION OF DRAWINGS

Understanding that the drawings depict only exemplary embodiments and are not therefore to be considered limiting in scope, the exemplary embodiments will be described with additional specificity and detail through the use of the accompanying drawings, in which:

FIG. 1 is a block diagram of a remote coordinate identifier system for an aircraft according to one embodiment;

FIG. 2 is a block diagram depicting data flow from a plurality of sensor inputs for the remote coordinate identifier system according to one embodiment;

FIG. 3 is a flow diagram for a remote coordinate identifier method according to one approach;

FIG. 4 illustrates a remote piloted vehicle (RPV) implemented with the remote coordinate identifier system;

FIG. 5 depicts the triangular pattern formed by an RPV altitude and a laser range finder distance from the RPV to a target; and

FIG. 6 is a block diagram showing a computer that can be employed in the remote coordinate identifier system according to one embodiment.

### DETAILED DESCRIPTION

In the following detailed description, reference is made to the accompanying drawings that form a part hereof, and in which is shown by way of illustration specific illustrative embodiments. It is to be understood that other embodiments may be utilized and that logical, mechanical, and electrical changes may be made. The following detailed description is, therefore, not to be taken in a limiting sense.

The embodiments described hereafter relate to a remote coordinate identifier system and method for use in aircraft, including Unmanned Aerial Vehicles (UAVs) such as a Remote Piloted Vehicle (RPV), as well as manned aircraft. In general, the system and method use Global Positioning System (GPS) information from a GPS receiver onboard the aircraft, navigation information from the aircraft navigation components, and inputs from a laser tracking system onboard the aircraft. An onboard computer processes this information to triangulate the position of an identified target and determine the precise map coordinates of the target. This target position information can then be transmitted to other aircraft or ground locations, such as missile launch sites, to provide accurate coordinates of the target for future precision attacks by another armed aircraft flying to the same area or a missile fired from afar.

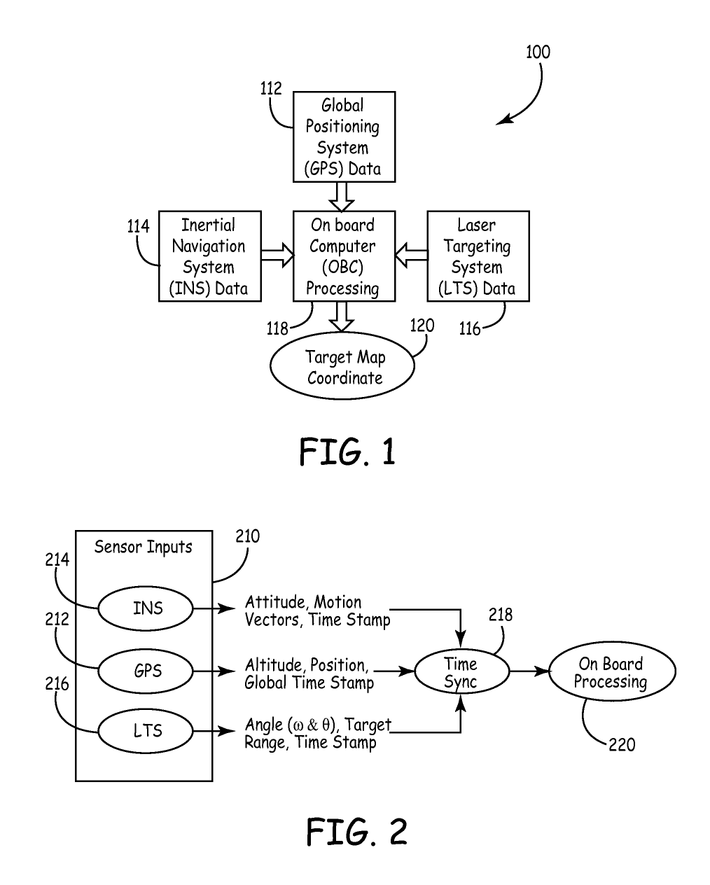

FIG. 1 illustrates a Remote Coordinate Identifier (RCI) system 100 for an aircraft according to one embodiment. The RCI system 100 comprises a GPS receiver 112 onboard the aircraft, with GPS receiver 112 configured to provide position information of the aircraft during flight. The RCI system 100 also includes an Inertial Navigation System (INS) 114 onboard the aircraft, with INS 114 configured to provide inertial information of the aircraft during flight. A Laser Targeting System (LTS) 116 is also provided in RCI system 100 onboard the aircraft, with the LTS 116 configured to provide angular measurements and distance measurements from the aircraft to an identified target during flight. The RCI system 100 further includes an onboard computer 118 in operative communication with GPS receiver 112, INS 114, and LTS 116. The computer 118 is configured to receive and process data from GPS receiver 112, INS 114, and LTS 116.

During operation of RCI system 100, GPS receiver 112 provides the current position data (3-axis coordinates) of the aircraft and provides the baseline for computer 118 to calculate the location of the target utilizing the inputs from INS 114 and LTS 116. The INS 114 provides inertial data to computer 118 to compensate for flight variables in the baseline and the data from LTS 116 as the aircraft is flying. The LTS 116 acts as a laser range finder and provides the distance from the aircraft to the target for one leg of a triangle as well as angular measurements to support the formulas used by computer 118 to triangulate the target map coordinates.

The computer 118 receives and processes the position data from GPS receiver 112, the inertial data from INS 114, and the distance and angular measurements from LTS 116 to triangulate the position of the identified target. The computer 118 then formulates the coordinates, compares the formulated coordinates against an electronic topographical map, and computes the precise map coordinates of the target. As shown in FIG. 1, a target map coordinate 120 is then output from computer 118 for transmission to other aircraft or ground locations for use in future air attacks of the target.

FIG. 2 is a block diagram depicting data flow from a plurality of sensor inputs 210 for the RCI system according to one embodiment. The sensor inputs 210 include a GPS sensor input 212, an INS sensor input 214, and an LTS sensor input 216, each of which are in operative communication with a time synchronization module 218. The GPS sensor input 212 transmits data related to altitude, position, and global time stamp to time synchronization module 218. The INS sensor input 214 transmits data related to attitude, motion vectors, and time stamp to time synchronization module 218. The LTS sensor input 216 transmits data related to angular measurements (ω, θ), target range (distance), and time stamp to time synchronization module 218. The time synchronization module 218 then transmits the time synchronized data to an onboard processing module 220 to compute the precise map coordinates of a target as described previously.

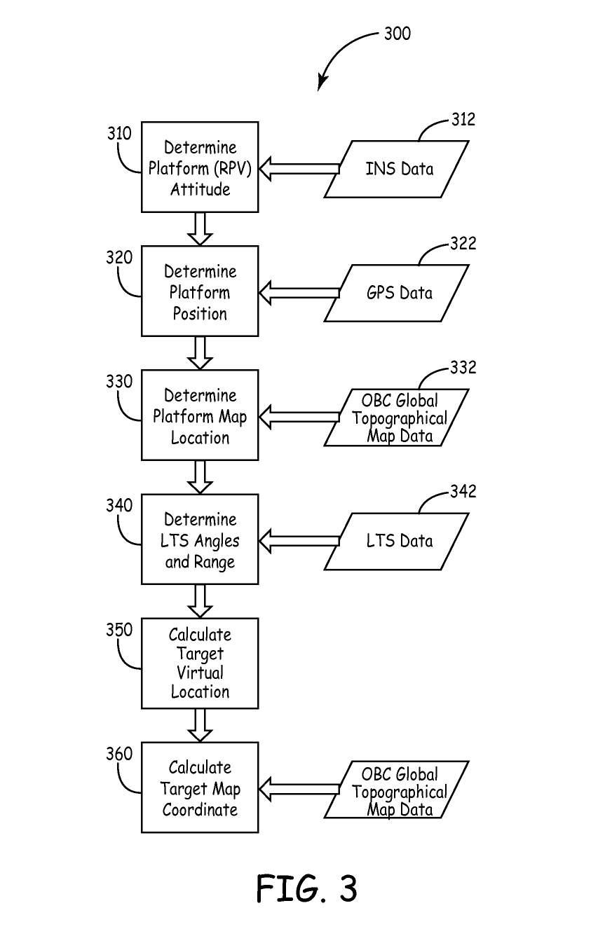

FIG. 3 is a flow diagram for a remote coordinate identifier method 300 according to one approach. Initially, a platform (e.g., RPV) attitude is determined (block 310) based on INS data 312 at a selected time. A platform position is determined (block 320) from GPS data 322 at the selected time. A platform map location is determined (block 330) from onboard computer (OBC) global topographical map data 332. The LTS angles and target range are determined (block 340) from LTS data 342 at the selected time. A target virtual location is then calculated (block 350) based on the platform attitude, the platform position, the platform map location, and the LTS angles and target range. A target map coordinate 360 is then calculated based on the target virtual location and OBC global topographical map data.

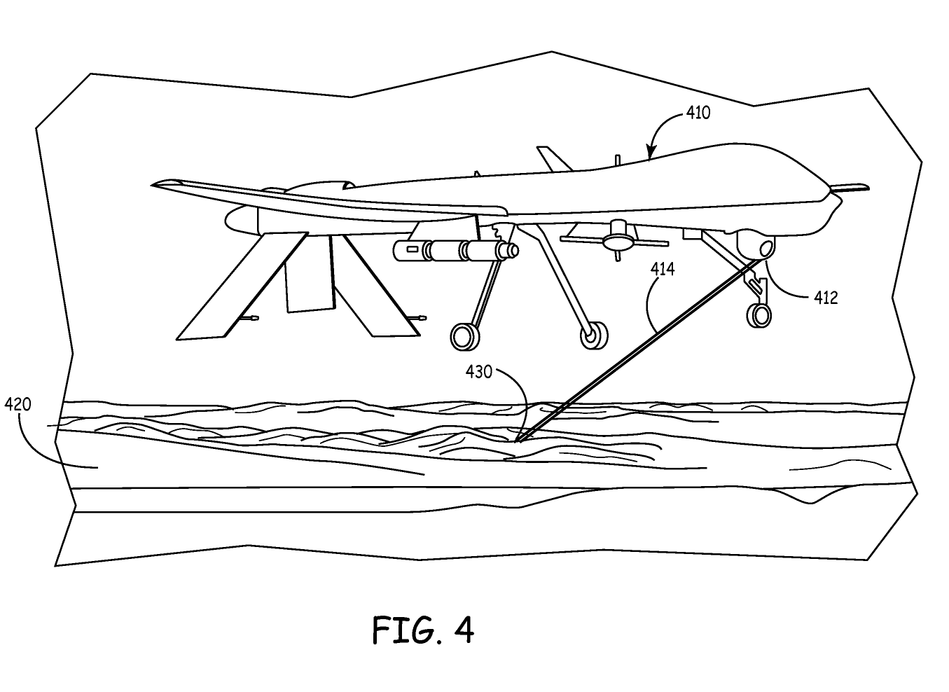

FIG. 4 illustrates an aircraft in the form of an RPV 410 implemented with the RCI system. The RPV 410 is shown in flight over a terrain 420 on which a target 430 is located. Although RPV 400 is depicted as a Predator drone, the RCI system can be implemented in other UAVs, as well as in manned aircraft. During operation of the RCI system, a laser range finder 412 on RPV 410 directs a laser beam 414 at target 430 and “paints” target 430. The altitude of RPV 410 above terrain 420 is determined using the GPS receiver data.

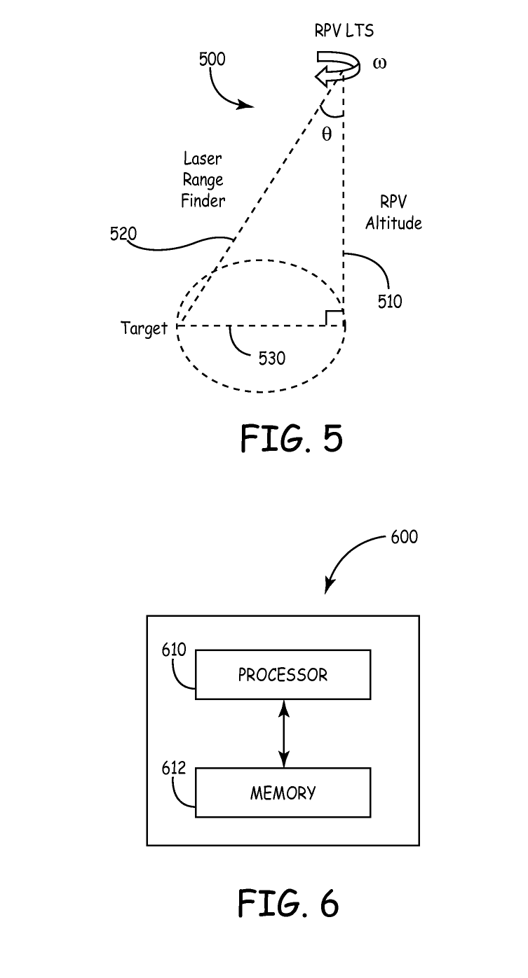

FIG. 5 depicts a triangular pattern 500 used by the RCI system on an aircraft such as an RPV to triangulate the position of a target. As shown in FIG. 5, an RPV altitude forms a vertical leg 510 of a right triangle. A distance measured by the laser range finder from the RPV to the target forms a hypotenuse 520 of the right triangle. The distance between the target and the ground position directly below the RPV forms a horizontal leg 530 of the right triangle. The angle (θ) between vertical leg 510 and hypotenuse 520 as well as the rotational angle (ω) of the RPV LTS are used along with the altitude and distance measurements to support the formulas that are employed to triangulate the location of the target. The angular measurement w is the measurement between the RPV LTS and the aircraft platform attitude. Standard triangulation formulas well known to those skilled in the art can be used in the present RCI system.

FIG. 6 depicts a computer system 600 that can be employed in the RCI system and method. The computer system 600 includes at least one processor 610, and at least one memory device 612 in operative communication with processor 610. The processor 610 can include one or more microprocessors, memory elements, digital signal processing (DSP) elements, interface cards, and other standard processing components. Any of the foregoing may be supplemented by, or incorporated in, specially-designed application-specific integrated circuits (ASICs), field programmable gate arrays (FPGAs), or other programmable logic devices.

The memory device 612 contains computer readable instructions for carrying out the various process tasks, calculations, and generation of signals and other data used in the operation of the RCI system and method. These instructions can be implemented in software, firmware, or other computer readable instructions. The memory device 612 also contains the global topographical map data to support the RCI system in calculating the RPV and target map coordinates. The memory device 612 may be any appropriate computer program product such as a computer readable medium used for storage of computer readable instructions. Such readable instructions can be in the form of program modules or applications, data components, data structures, algorithms, and the like, which perform particular tasks or implement particular abstract data types. The computer readable medium can be selected from any available computer readable media that can be accessed by a general purpose or special purpose computer or processor, or any programmable logic device.

Suitable processor or computer readable media may comprise, for example, non-volatile memory devices including semiconductor memory devices such as EPROM, EEPROM, or flash memory devices; magnetic disks such as internal hard disks or removable disks; magneto-optical disks; CDs, DVDs, or other optical storage disks; nonvolatile ROM, RAM, and other like media; or any other media that can be used to store desired program code in the form of computer executable instructions.

The described embodiments are to be considered in all respects only as illustrative and not restrictive. The scope of the invention is therefore indicated by the appended claims rather than by the foregoing description. All changes that come within the meaning and range of equivalency of the claims are to be embraced within their scope.

What is claimed is:

1. A remote coordinate identifier system for an aircraft, the system comprising:
a global positioning system (GPS) receiver onboard the aircraft, the GPS receiver configured to provide position information of the aircraft during flight;
an inertial navigation system (INS) onboard the aircraft, the INS configured to provide inertial information of the aircraft during flight;
a laser targeting system (LTS) onboard the aircraft, the LTS configured to provide angular information and distance measurements from the aircraft to an identified target during flight; and
a computer onboard the aircraft, the computer configured to:
process the position information, the inertial information, the angular information, and the distance measurements to triangulate a position of the target; and
determine map coordinates for the target from the triangulated position of the target.

2. The system of claim 1, wherein the aircraft comprises a manned aerial vehicle or an unmanned aerial vehicle.

3. The system of claim 2, wherein the unmanned aerial vehicle comprises a remote piloted vehicle.

4. The system of claim 1, wherein the computer comprises at least one processor in operative communication with a time synchronization module.

5. The system of claim 4, further comprising a plurality of sensor inputs in operative communication with the time synchronization module.

6. The system of claim 5, wherein the plurality of sensor inputs comprise a GPS sensor input, an INS sensor input, and an LTS sensor input.

7. The system of claim 6, wherein the GPS sensor input transmits information comprising altitude data, position data, and global time stamp data to the time synchronization module.

8. The system of claim 6, wherein the INS sensor input transmits information comprising attitude data, motion vectors, and time stamp data to the time synchronization module.

9. The system of claim 6, wherein the LTS sensor input transmits information comprising angular data, target range, and time stamp data to the time synchronization module.

10. A method for remotely identifying the coordinates of a target from an aircraft having a laser targeting system (LTS), the method comprising:
determining an attitude of the aircraft during flight at a selected time;
determining a position of the aircraft at the selected time;
determining a map location of the aircraft;
determining angular measurements for the LTS with respect to the attitude of the aircraft;
determining a distance from the aircraft to an identified target at the selected time;
calculating a virtual location of the target based on the attitude, the position, the map location, the angular measurements, and the distance; and
calculating a map coordinate for the target based on the target virtual location.

11. The method of claim 10, wherein the aircraft comprises a manned aerial vehicle or an unmanned aerial vehicle.

12. The method of claim 11, wherein the unmanned aerial vehicle comprises a remote piloted vehicle.

13. The method of claim 10, wherein the attitude of the aircraft is determined from inertial data.

14. The method of claim 10, wherein the position of the aircraft is determined from GPS data time synchronized with the inertial data.

15. The method of claim 14, wherein the map location of the aircraft is determined from global topographical map data.

16. The method of claim 15, wherein the angular measurements and the distance are determined from laser tracking data time synchronized with the GPS data and the inertial data.

17. The method of claim 10, wherein calculating the virtual location of the target comprises triangulating the position of the target.

18. The method of claim 10, wherein calculating the map coordinate for the target is further based on global topographical map data.

19. A computer program product, comprising:
a computer readable medium having instructions stored thereon executable by a processor to carry out a method for remotely identifying the coordinates of a target from an aircraft having a laser targeting system (LTS), the method comprising:
determining an attitude of the aircraft during flight at a selected time;
determining a position of the aircraft at the selected time;
determining a map location of the aircraft;
determining angular measurements for the LTS with respect to the attitude of the aircraft;
determining a distance from the aircraft to an identified target at the selected time;
calculating a virtual location of the target based on the attitude, the position, the map location, the angular measurements, and the distance; and
calculating a map coordinate for the target based on the target virtual location.

20. The computer program product of claim 19, wherein calculating the virtual location of the target comprises triangulating the position of the target.
